(19) United States
(12) Patent Application Publication
(10) Pub. No.: US 2020/0160331 A1
(43) Pub. Date: May 21, 2020

(54) SYSTEM AND METHOD FOR FACILITATING SAFE HANDLING OF A PHYSICAL MEDIUM OF FINANCIAL EXCHANGE

(71) Applicant: International Business Machines Corporation, Armonk, NY (US)

(72) Inventors: Toby Kurien, Johannesburg (ZA); Ashley D. Gritzman, Johannesburg (ZA); Ismail Y. Akhalwaya, Johannesburg (ZA); Naweed Khan, Johannesburg (ZA)

(21) Appl. No.: 16/197,433

(22) Filed: Nov. 21, 2018

(51) Int. Cl. G06Q 20/38; H04L 9/08; G07D 7/0047; G07D 11/00

(52) U.S. Cl. CPC G06Q 20/3829; G06Q 20/381; H04L 2209/38; G07D 7/0047; G07D 11/0093; H04L 9/0819

(57) ABSTRACT

A method 30 and system 10 for facilitating safe handling of a physical medium of financial exchange, such as cash notes is provided to prevent cash-in-transit heists. The method 30 includes physically marking 33, using a first processing device 8, cash with a unique owner identifier which is associated with the owner of the cash, and physically invalidating 34 the cash through cutting, staining or stamping it. Once invalidated, the worthless cash can be transported risk-free to a desired cash processing facility. Upon arrival, the method includes verifying 44, using an authentication module 24, authenticity of the unique owner identifier and cash notes themselves. If verification fails, law enforcement is notified. If passed, the cash is destroyed 38, using a second processing device 9 which digitizes, using a digitizer 22, the cash notes and transfers a digital equivalent value, which is credited to the owner's account, to an electronic record keeping system 12.

### BACKGROUND

The present invention relates to digitization of money. More specifically, an embodiment of the invention relates to a method and system for converting physical currency into digital currency.

Most businesses trade in cash. Dealing in cash is inherently risky as it makes a business vulnerable to theft or robbery. Large amounts of stowed cash may lure criminals into targeting the business. Furthermore, it is costly, inefficient and dangerous to handle, store and transport cash. Cash stored onsite needs to be stored in a safe or vault and access to the vault needs to be carefully controlled and regulated. If keys to the vault are kept onsite, it poses a serious risk to employees as armed intruders may compel the employees to open the vault at gun point in order to gain access to the cash. Criminals may also attack whilst cash is being transported to a bank.

A country like South Africa has been experiencing a deadly scourge of cash-in-transit heists. These heists usually involve a gang of criminals, who are not hesitant to use deadly force and explosives to gain access to the cash, swooping on an armoured cash-in-transit vehicle. In what is known as a “cross pavement” attack, robbers target cash-in-transit personnel during cash collection, when they are at their most vulnerable.

### SUMMARY

According to an embodiment of the present invention, there is provided a method of facilitating safe handling of a physical medium of financial exchange, the method including:

assigning, using a first processing device, the physical medium of financial exchange to an owner;

rendering, using the first processing device, the physical medium of financial exchange worthless or inutile;

verifying, using a second processing device, authenticity of the worthless physical medium of financial exchange;

destroying, using the second processing device, the physical medium of financial exchange; and

transferring, using the second computing device, a digitized form of the physical medium of financial exchange to an electronic record keeping system. An embodiment of the present invention extends to a corresponding system for facilitating safe handling of a physical medium of financial exchange.

### BRIEF DESCRIPTION OF THE DRAWINGS

FIG. 1 illustrates a functional block diagram of a system for facilitating safe handling of a physical medium of financial exchange in accordance with an embodiment of the invention; and

FIG. 2 illustrates a flow diagram of a method of facilitating safe handling of the physical medium of financial exchange.

### DETAILED DESCRIPTION

Examples and aspects are discussed below with reference to the FIGS. However, it should be understood that the detailed description given with respect to these FIGS. is for explanatory purposes only, and not by way of limitation.

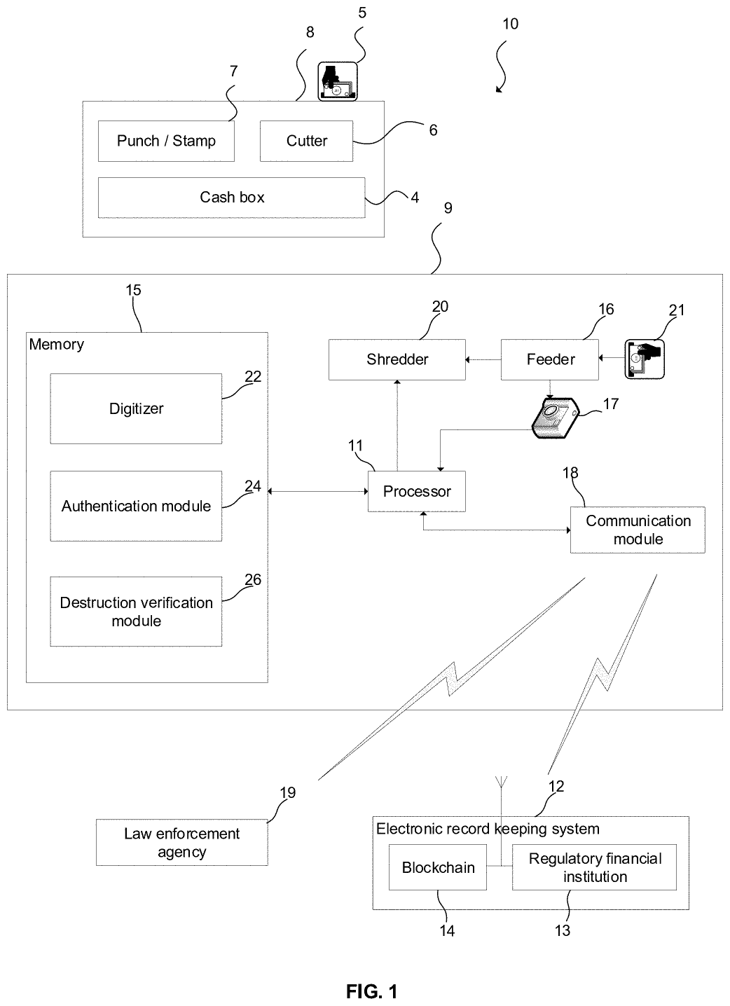

In FIG. 1, reference numeral 10 refers generally to a system for facilitating safe handling of a physical medium of financial exchange. In the example embodiment illustrated and described the physical medium of financial exchange is cash. It is to be appreciated that the scope of protection is not limited to cash and, accordingly, it extends to other mediums of financial exchange such as cheques, government bonds or gilts, as well. The system 10 may include a first processing device which, in this example embodiment, may take the form of a first cash processing machine 8, which is configured to receive and process cash 5 at a store, business or any other location dealing in cash. The first cash processing machine 8 may be used to invalidate or render the cash 5 worthless to everyone except an owner of the cash 5, in order to lower the cash heist risk associated with transporting the cash 5 to a remote destination such as a bank or other financial institution.

To this end, the first cash processing machine 8 may define a cash slot (not shown) for dropping or feeding a stack of cash notes into a cash processing cavity defined by the machine 8. The first cash processing machine 8 may include a cutter 6, which may be in the form of a laser cutter, which is configured to render the cash worthless or inutile by irreversibly, mechanically invalidating the cash 5 by, for example, cutting the word “INVALID” out of the cash notes using the laser cutter. Alternatively, or in addition, a punch or stamp 7 of the first cash processing machine 8 may be used to stamp or stain the word “INVALID” onto the cash notes whilst making sure to leave serial numbers of the cash notes legible. The first cash processing machine 8 may also be configured to mark the cash notes with a unique owner identifier, for example, a user/owner code which is associated with an owner of the cash and which points to the owner. Once the cash 5 has been marked with the unique owner identifier and invalidated, it is securely stored in a cash box 4 or vault of the first cash processing machine 8 until further processing is performed. The invalidated cash can now be transported risk-free to a desired destination due to the fact that the cash has been rendered inutile or worthless to everyone else except the owner thereof.

In a more sophisticated embodiment of the first cash processing machine 8, which has not been illustrated in the drawings, the machine 8 may include an optical device, e.g. a camera, which is configured to verify authenticity of the cash 5, and record serial numbers and optical properties of the cash notes, for example, by storing photographs of the original cash notes, prior to marking or invalidating the cash notes 5. The recorded properties or photographs of the cash notes may then be electronically or digitally transmitted to a second remote cash processing device.

To this end, the system 10 may include a second processing device which, in this example embodiment, may take the form of a second cash processing machine 9. The second cash processing machine 9 may include a feeder 16 for further processing invalidated cash 21 retrieved from the cash box 4 of the first cash processing machine 8. The second cash processing machine 9 may be communicatively linked to an electronic record keeping system 12 for allowing digital records of the cash processed by the second cash processing machine 9 to be forwarded to the electronic record keeping system 12 for digital storage. The second cash processing machine 9 may also be communicatively linked to a law enforcement agency 19 to report any irregularities, fraudulent activity or counterfeit cash detected to the law enforcement agency. To this end, the second cash processing machine 9 may include a processor 11, memory 15 which is communicatively coupled to or integrated into the processor 11, a camera 17 or other device suitable to record or detect optical characteristics of the cash 21, and a communication module 18 which is communicatively coupled to the processor 11 and is configured to communicate with the remote electronic record keeping system 12 and the law enforcement agency 19.

The electronic record keeping system 12 may include a regulatory financial institution 13 such as a bank. Alternatively, or in addition, the electronic record keeping system 12 may include a blockchain 14, serving as a public digital ledger of the digitized records of the cash.

The feeder 16 may be configured to process a stack of cash notes of varying denominations, one at a time. The second cash processing machine 9 may further include a shredder 20 or cutter which is operatively downstream of the feeder 16 and is configured physically to destroy processed cash notes by either shredding the notes into fine strips, which are discharged by the machine 9, or otherwise destroying the notes 21, for example, by incinerating or chemically dissolving them. From a software perspective, the second cash processing machine 9 may include modules which are stored in the memory 15. In the embodiment of the invention illustrated in FIG. 1, these include a digitizer 22, an authentication module 24, and a destruction verification module 26. The function of these respective modules 22, 24, 26 will be elaborated on below.

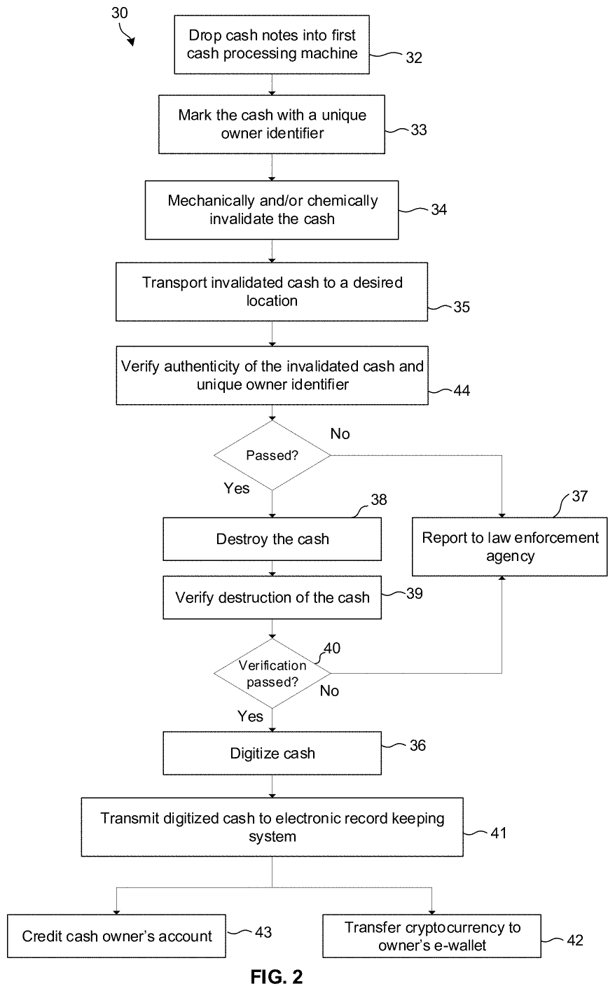

Reference is now made to FIG. 2, where numeral 30 refers generally to a method of facilitating safe handling of the physical medium of financial exchange, which, as mentioned earlier, is cash in this example embodiment. As a first step, the method 30 may include dropping 32 or feeding the cash notes 5 into the cash processing cavity of the first cash processing machine 8 via the cash slot. The first cash processing machine 8 may be configured to receive as input a unique owner identifier associated with an owner of the cash via a digital user interface of the machine 8. In order words, after slotting the cash 5 into the machine 8, an operator overseeing the cash processing process, may enter the unique owner identifier associated with the owner of the cash into the user interface of the machine 8 and initiate processing of the cash 5 by the machine 8. The first cash processing machine 8 then marks 33 every note of the cash 5 with the unique owner identifier through use of the punch 7. In addition, the first cash processing machine 8 invalidates 34 each note by cutting the word “INVALID” out of the notes using the cutter 6 or alternatively staining the notes. Once this has been done, validity of the cash can be easily ascertained by simply glancing at the cash.

The invalidated cash is passed from the cash processing cavity of the first cash processing machine 8 into the cash box 4 or vault. In the example embodiment illustrated, the cash box 4 is an integral part of the first cash processing machine 8. However, the cash box or vault may be separable from the first cash processing machine 8 for transportation 35 of the invalidated cash to a remote location.

Upon safe arrival of the cash at its intended or desired location, the cash is discharged, or otherwise removed from the cash box 4 or vault and fed into the feeder 16 of the second cash processing machine 9 which is under the direct control of a financial institution. As the feeder 16 feeds the notes into the machine 9, the camera 17, which is coupled to the processor 11, records a serial number, the unique owner identifier and optionally other optical characteristics of each passing note. The recorded serial numbers, owner identifier and other optical characteristics may be stored in memory 15. The method 30 may further include verifying 44, using the authentication module 24, authenticity of the unique owner identifier, a denomination or value of the cash and authenticity of each of the cash notes 21 by performing any one of a number of checks which are known in the art including: optical character recognition, watermark detection, ultraviolet mark detection using an ultraviolet light, texture analysis and edge-detection image processing. The authentication module 24 may be configured to perform counterfeit detection of cash notes. Furthermore, the method 30 may include verifying the authenticity of the cash notes by comparing the recorded serial numbers of the cash against records kept remotely at the regulatory financial institution 13. This may include matching the recorded serial numbers against remotely stored records to authenticate the cash notes. Verification of authenticity of the cash notes may also include comparing the recorded serial numbers, owner identifiers and/or optical characteristics of the cash 21 against recorded data of the cash 5 received from the first cash processing machine 8. If any fraudulent notes are detected, or any of the verification steps failed, the second cash processing machine 9 reports 37 or otherwise notifies the law enforcement agency 19 via the communication module 18.

Provided that the second cash processing machine 9 has established authenticity of the cash notes, the cash notes are passed on to the shredder 20 for final and complete, irreversible destruction. The shredder 20 destroys 38 the cash notes by shredding the notes into strips which are discharged by the machine 9 and optionally recycled. In order to prevent fraud, the method 30 may include verifying 39 using the camera 17 and the destruction verification module 26 that the cash has been completed destroyed. If the destruction verification module 26 establishes 40 that destruction was partial or incomplete, the relevant law enforcement agency 19 may be informed.

Using the digitizer 22, the method 30 may include converting 36 the cash notes into digitized form, i.e. converting the cash into cryptocurrency. Alternatively, following digitization 36 of the cash, a verified amount of the cash is electronically transmitted 41 to the regulatory financial institution 13 and credited 43 to an appropriate account associated with the owner of the cash. Digitization 36 of the cash notes may be based upon the recorded serial numbers and optical characteristics of the cash notes. The method 30 may include generating a unique digital key of each cash note. The digital key may be configured to store a value which is representative of and corresponds with the physical value of the cash. The digital keys may be associated with physical and/or optical characteristics of the cash notes. Generating the digital key may include combining, using the digitizer 22, any two or more of a monetary value, the serial number, and optical characteristics of the cash to form the digital key. Accordingly, the method 30 may include transferring or transmitting, using the communication module 18, the digital key to the electronic record keeping system 12. The method 30 may include adding the digital key or digitized form of the cash to the blockchain 14 and/or forwarding the digital key to the regulatory financial institution 13.

Validation or authentication of cash is a sensitive process that is susceptible to fraud. Therefore, this process must be performed in a secure manner An option to mitigate the risk of fraud is to provide a cash digitization device in a tamper proof enclosure, with an alarm system to guard against intrusion. However, this does not fully address the problem, and significantly increases the cost of such devices. Furthermore, technology and sensors required to perform validation checks of paper currency further increase the cost and complexity of such digitization devices. The system 10 and method 30 address these issues by marking the paper currency with the unique owner identifier, and then disabling or invalidating the paper currency, for example, by staining it with the word “INVALID”. The invalidated paper currency is worthless to anyone aside from the owner whose mark is on the cash, and thus no longer presents a target for criminals. The invalidated cash can now be stored and transported by ordinary mechanisms which no longer requires heightened security measures. Once transported to a secure processing facility, the cash can be authenticated, completely destroyed, and the value thereof credited to a digital account belonging to the owner. Since authentication and destruction takes place at a secure processing facility, the cost and complexity of the cash processing machines can be significantly reduced.

Instead of maintaining an electronic record to which serial numbers are loaded, the first cash processing machine 8 may be configured to stamp or cut the unique owner identifier into the notes. The unique owner identifier will subsequently be read by the second cash processing machine 9, thereby serving to identify the owner to whom the money must be credited. In this embodiment, the marking and the invalidating stamping operations are combined into one simple device, which can be in the form of a simple mechanical paper punch that could even be integrated into business cash tills. If stain is used to invalidate the cash, a recyclable, special DNA-based dye that is only susceptible to a specific secret washing agent (potentially coded into the DNA) could be used.

Instead of transporting the invalidated cash to a processing facility, the second cash processing machine 9 can be brought to the business premises and the invalidated cash can be processed on site. This can be done periodically as and when enough cash has accumulated (e.g. once per month). This portable second cash processing machine would need to perform all functionality including verification, destruction, and recording in an electronic database. In this embodiment, invalidating the cash allows for safe storage until such time as the cash has been processed.

Instead of crediting 43 the owner's bank account with an amount equivalent to the value of the invalidated cash, this amount can be credited or transferred 42 to a blockchain-based cryptocurrency. This can be accomplished in several ways. For example, the Reserve Bank may maintain a blockchain-based cryptocurrency pegged to the country's currency (e.g. 1 coin in the network may be equivalent to 1 USD). Each time a note is printed, the value of the note is written to the blockchain as coins of equivalent value and put into an “in-circulation” wallet. In the case of existing currency already in circulation, the Reserve Bank can use its database of valid serial numbers and note values to preload the blockchain with the correct currency values. After authentication and destruction, the determined cash value can be transferred by the Reserve Bank (or by the cash processing machines) from the “in-circulation” wallet to the owner's own cryptocurrency wallet.

Alternatively, the Reserve bank may mint new cryptocurrency coins only when the equivalent paper currency has been destroyed. In this case, the transaction to move coins from the “in-circulation” wallet to the cash owner's wallet is “signed off” automatically by the processing machines (all under the direct control of the Reserve bank). Here the cash processing machines may instruct a separate central Reserve Bank node to mint fresh coins. Verification steps may be performed to check and record that serial numbers being processed have not been minted before to prevent duplication or fraud.

The laser cutter 6 may be configured to cut a grid of dots out of the cash notes for minimal destruction but maximal visibility. The unique owner identifier may be in the form of a cryptographic key, such as a private-public key, or a serial number unique to the owner.

It is not necessary for the notes to be transported with heightened security, for example, using an armored vehicle since the notes are worthless to anyone besides the owner.

The Applicant believes that the method 30 and system 10 for facilitating safe handling of a physical medium of financial exchange in accordance with the embodiment of the invention will diminish, if not, eradicate the scourge of cash-in-transit heists by physically rendering the cash inutile or worthless before transporting it. In this manner, security of dealing with physical cash can be improved. Due to the fact that the second cash processing machine 9 verifies authenticity of the invalidated cash, the on-site first cash processing machine 8 does not need to be trusted, i.e. it need not be tamperproof which means it can be fairly cost effective. By implication, the first cash processing machine 8 needn't be rigorously controlled by financial institutions and can be made more cost effective.

What is claimed is:

1. A method of facilitating safe handling of a physical medium of financial exchange, the method including:
assigning, using a first processing device, the physical medium of financial exchange to an owner;
rendering, using the first processing device, the physical medium of financial exchange worthless or inutile;
verifying, using a second processing device, authenticity of the worthless physical medium of financial exchange;
destroying, using the second processing device, the physical medium of financial exchange; and
transferring, using the second computing device, a digitized form of the physical medium of financial exchange to an electronic record keeping system.

2. A method as claimed in claim 1, wherein assigning includes physically marking, using the first processing device, the physical medium of financial exchange with a unique owner identifier which is associated with the owner of the physical medium of financial exchange.

3. A method as claimed in claim 2, which includes, prior to destroying, converting, using the first or second processing device, the physical medium of financial exchange into a digitized form in which it holds equivalent value as in physical form.

4. A method as claimed in claim 3, which includes irreversibly rendering the physical medium of financial exchange worthless.

5. A method as claimed in claim 1, which includes verifying, using the second processing device, that the physical medium of financial exchange has been destroyed.

6. A method as claimed in claim 1, wherein the physical medium of financial exchange is cash, rendering worthless including mechanically and/or chemically invalidating the cash.

7. A method as claimed in claim 6, wherein verifying authenticity of the physical medium of financial exchange includes determining and recording unique identifiers of the cash using an authentication module of the second processing device.

8. A method as claimed in claim 7, wherein recording unique identifiers includes recording any one of serial numbers, optical characteristics and monetary value of the cash.

9. A method as claimed in claim 8, which includes verifying, using the second processing device, the recorded unique identifiers against records of a regulatory financial institution.

10. A method as claimed in claim 9, which includes alerting a law enforcement agency in the event that an irregularity is detected.

11. A method as claimed in clam 3, which includes crediting an account of the owner held at the electronic record keeping system with a value corresponding to a monetary value of the destroyed physical medium of financial exchange.

12. A method as claimed in claim 3, wherein the electronic record keeping system includes use of blockchain technology.

13. A method as claimed in claim 12, which includes minting blockchain-based cryptocurrency corresponding to a monetary value of the destroyed physical medium of financial exchange.

14. A method as claimed in claim 13, which includes transferring a blockchain-based cryptocurrency value corresponding to the monetary value of the destroyed physical medium of financial exchange owned by the owner, to the owner.

15. A system for facilitating safe handling of a physical medium of financial exchange, the system including a first processing device and a second processing device which is communicatively coupled to an electronic record keeping system, wherein the first processing device is configured to:
mark the physical medium of financial exchange with a unique owner identifier which is associated with the owner of the physical medium of financial exchange; and
render the physical medium of financial exchange worthless by mechanically and/or chemically invalidating the physical medium of financial exchange; and wherein the second processing device is configured to:
verify authenticity of the invalidated physical medium of financial exchange;
destroy the invalidated physical medium of financial exchange; and
transfer a digitized form of the physical medium of financial exchange to the electronic record keeping system.

16. A system as claimed in claim 15, wherein the first processing device includes a drop safe which is configured to:
receive a stack of cash into a cash handling zone;
mark the stack of cash with the unique owner identifier;
invalidate the stack of cash; and
temporary store the invalidated stack of cash.

17. A system as claimed in claim 16, wherein the drop safe includes any one of a cutter, a punch and a stamp for marking and invalidating the cash.

18. A system as claimed in claim 15, wherein the second processing device is further configured to verify, using a camera, that the physical medium of financial exchange has been destroyed.

19. A system as claimed in claim 15, wherein the unique owner identifier is in the form of a cryptographic key.

20. A system as claimed in claim 15, wherein the unique owner identifier is in the form of a serial number.
